(19) United States
(12) Patent Application Publication
(10) Pub. No.: US 2010/0330419 A1
(43) Pub. Date: Dec. 30, 2010

(54) ELECTROSPINNING TO FABRICATE BATTERY ELECTRODES

(76) Inventors: Yi Cui, Sunnyvale, CA (US); Song Han, Foster City, CA (US); Ghyrn E. Loveness, Menlo Park, CA (US); Mark C. Platshon, Menlo Park, CA (US)

Correspondence Address: Weaver Austin Villeneuve & Sampson LLP, P.O. BOX 70250, OAKLAND, CA, 94612-0250, US

(21) Appl. No.: 12/787,132

(22) Filed: May 25, 2010

Related U.S. Application Data
(60) Provisional application No. 61/183,529, filed on Jun. 2, 2009.

(51) Int. Cl. H01M 4/02; B05D 5/12; H01M 4/82

(52) U.S. Cl. 429/209; 427/458; 29/623.5; 427/77

(57) ABSTRACT

Provided are electrode assemblies that contain electrochemically active materials for use in batteries, such as lithium ion batteries. Provided also are methods for fabricating these assemblies. In certain embodiments, fabrication involves one or more electrospinning operations such as, for example, electrospinning to deposit a layer of fibers on a conductive substrate. These fibers may include one or more electrochemically active materials. In the same or other embodiments, these or similar fibers can serve as templates for depositing one or more electrochemically active materials. Some examples of active materials include silicon, tin, and/or germanium. Also provided are electrode fibers that include cores containing a first active material and shells or optionally second shells (surrounding inner shells) containing a second active material. The second active material is electrochemically opposite to the first active material. One or more shells can function as a separator and/or as an electrolyte.

### CROSS-REFERENCE TO RELATED APPLICATIONS

This application claims the benefit of U.S. Provisional Patent Application No. 61/183,529, filed Jun. 02, 2009, entitled “Electrospinning to Fabricate Battery Electrodes,” which is incorporated herein by reference in its entirety for all purposes.

### TECHNICAL FIELD

The present invention relates generally to electrochemical cell components and methods of fabricating such components and, more specifically, to battery electrodes prepared using electrospinning.

### BACKGROUND

There is a demand for high capacity rechargeable batteries. Many applications, such as aerospace, medical devices, portable electronics, automotive and others, require high gravimetric and/or volumetric capacity batteries. Nanostructures including nanofibers, nanowires, core-shell structures, and such provide new opportunities in this area. However, manufacturing methods of producing these nanostructures are complex and often not practical for typical electrochemical cells used in consumer electronics, automotive applications, and such. Overall, there is a need for new processes to fabricate electrochemical cell components.

### SUMMARY

Provided are electrode assemblies that contain electrochemically active materials for use in batteries, such as lithium ion batteries. Provided also are methods for fabricating these assemblies. In certain embodiments, fabrication involves one or more electrospinning operations such as, for example, electrospinning to deposit a layer of fibers on a conductive substrate. These fibers may include one or more electrochemically active materials. In the same or other embodiments, these or similar fibers can serve as templates for depositing one or more electrochemically active materials. Some examples of active materials include silicon, tin, and/or germanium. Also provided are electrode fibers that include cores containing a first active material and shells or optionally second shells (surrounding inner shells) containing a second active material. The second active material is electrochemically opposite to the first active material (e.g., the core could contain negative electrode active material and the shell could contain positive electrode active material). One or more shells can function as a separator and/or as an electrolyte.

In certain embodiments, a method for fabricating an electrode assembly including an electrochemically active material is provided. The electrode assembly can be used in a battery, such as a lithium ion battery. The method includes providing a thin film substrate having a first surface and a second surface and depositing an initial layer including first electrospun fibers on the first surface using an electrospinning deposition technique. The electrospun fibers include one or more electrochemically active materials. The method may also include depositing, using an electrospinning deposition technique, a second layer that includes second electrospun fibers. In certain embodiments, the method proceeds with one or more of the following operations: annealing, calcining, carbonizing, sintering, compressing, and cooling.

In certain embodiments, a second layer is deposited on the second surface of the substrate. An initial layer and second layer may have substantially the same thicknesses and substantially the same compositions. In certain embodiments, an initial layer includes a negative active material. A second layer may include a positive active material. Furthermore, a thin film substrate may include a permeable membrane, such as a battery separator, a battery electrolyte, or a combination of a battery separator and electrolyte. In certain embodiments, an initial layer and/or second layer include discrete patches positioned on the substrate such that some portions of the first surface and/or the second surface of the substrate are exposed in between these patches. The discrete patches may be formed using two mechanical stops and/or an electrical shield.

In certain embodiments, a second layer is deposited over the initial layer. The method may also include depositing a third layer containing third electrospun fibers over the second layer, depositing a fourth layer containing fourth electrospun fibers over the third layer and separating the initial layer from the substrate to form a stack that includes four layers, i.e., the initial layer, the second layer, the third layer, and the fourth layer. The first layer includes electrospun fibers that may include one or more electrochemically active materials. The third electrospun fibers include a different active material. For example, a first layer may include a positive active material, while a third layer may include a negative active material or vice versa. The fourth layer and second layer may have substantially the same thickness and substantially the same composition and include a battery separator, a battery electrolyte, or a combination of a battery separator and electrolyte. The method may also include winding the stack that includes the four layers into a jellyroll and positioning the jellyroll into a battery case.

In certain embodiments, an electrode assembly includes an electrolyte material. In the same or other embodiments, electrospun fibers of an initial layer include two groups of fibers: a first group including one electrochemically active material and a second group including a different electrochemically active material. Examples of electrochemically active materials include silicon, germanium, and tin. In certain specific example, an electrochemically active material includes silicon nanowires. In certain embodiments, a substrate used for depositing a layer of electrospun fibers is a continuous foil of one or more of the following types: a copper foil, a stainless steel foil, an aluminum foil, a titanium foil, a Mylar film, a polymer paper, a carbon a fiber paper, and a carbon fiber mesh. In certain embodiments, depositing an initial layer comprises feeding a liquid precursor through an electrospinning nozzle. The liquid precursor includes a polymer base and active material particles.

In certain embodiments, a method for fabricating an electrode layer includes depositing an initial layer that includes electrospun fibers. The fibers have core-shell structures and include one or more electrochemically active materials. The method may involve processing the initial layer to change the shapes and/or compositions of the electrospun fibers in order to form an electrode layer. During processing, the solid cores are changed into hollow cylinders. Processing may include drying out a solvent from the electrospun fibers and/or performing one or more post-deposition treatments, such as annealing, calcining, carbonizing, sintering, compressing, and/or cooling.

In certain embodiments, a method for fabricating an electrode layer involves depositing an initial layer that includes electrospun fibers. The electrospun fiber may include a polymer material. The method may also involve forming a amorphous silicon coating silicon around the electrospun fibers and processing the initial layer to form the electrode layer. The electrospun fibers may include an electrochemically active material.

In certain embodiments, an electrode fiber for use in a battery electrode includes a core having a first electrochemically active material, a shell formed around the core, and a second shell formed around the shell and including a second electrochemically active material that is electrochemically opposite to the first active material. The inner shell may include a separator material and/or an electrolyte material and may provide an electronic insulation between the core and the second shell. The shell may also be configured to transport electrochemically active ions between the core and the second shell.

These and other aspects of the invention are described further below with reference to the figures.

### BRIEF DESCRIPTION OF THE DRAWINGS

FIG. 1 illustrates an example of a general process for fabrication an electrochemical cell.

FIGS. 2A-B illustrate an example of an electrospinning apparatus for depositing one or more layer of an electrode in accordance with certain embodiments.

FIG. 3 illustrates an example of a general process for depositing one or more layer of an electrode in accordance with certain embodiments.

FIG. 4A is an illustrative representation of an battery fiber ejected from the electrospinning nozzle.

FIG. 4B illustrates two examples of battery fibers in accordance with certain embodiments.

FIGS. 5A and 5B illustrate top and side views of a patch including a substrate and four battery layers in accordance with certain embodiments.

FIG. 6 illustrates a cross-section view of the wound cylindrical cell in accordance with one embodiment.

### DETAILED DESCRIPTION OF EXAMPLE EMBODIMENTS

In the following description, numerous specific details are set forth in order to provide a thorough understanding of the present invention. The present invention may be practiced without some or all of these specific details. In other instances, well known process operations have not been described in detail to not unnecessarily obscure the present invention. While the invention will be described in conjunction with the specific embodiments, it will be understood that it is not intended to limit the invention to the embodiments.

### Introduction

A typical process 100 for electrochemical cell fabrication is illustrated in

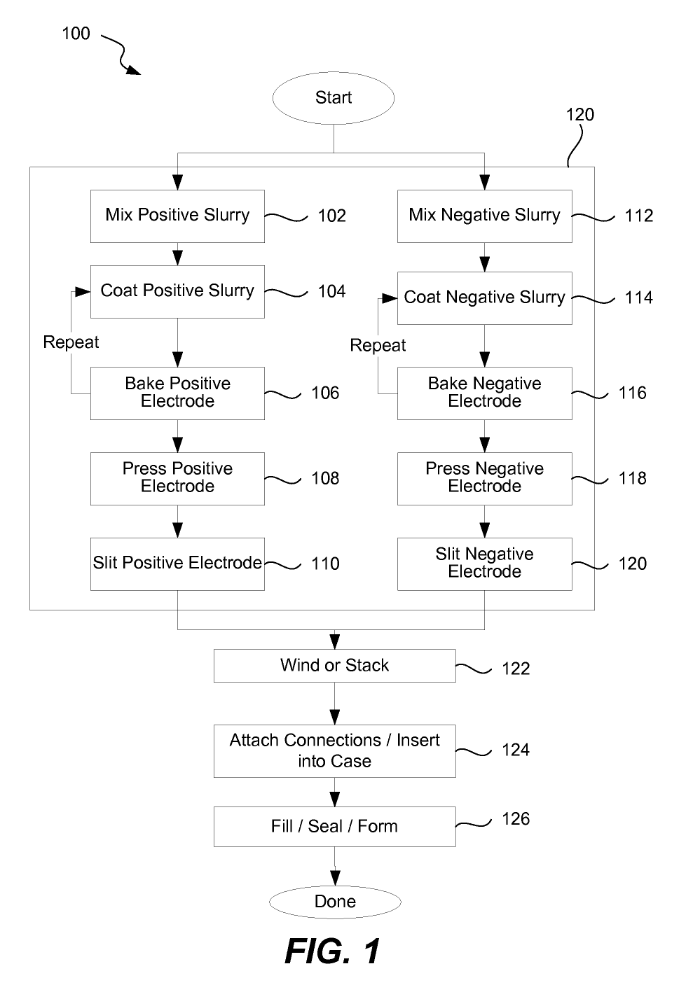

FIG. 1. It involves multiple operations to prepare two electrodes and then assemble these electrodes into a complete cell. The electrode preparation part 120 of fabrication is particularly labor intensive. Typically, a process starts with mixing active materials into slurries (blocks 102 and 112) and coating these slurries onto the corresponding substrates (blocks 104 and 114). The coated slurries are baked to evaporate solvent and to form a solid coating (block 106 and 116). The process of coating and baking is repeated on the second side of each electrode. The electrodes may then undergo pressing (blocks 108 and 118) and slitting (blocks 110 and 120). Positive and negative electrodes can be then stacked or wound together (block 122) and processed into an operational cell by attaching electrical connections and positioning the resulting electrode assembly into a case block 124) and then by filling with electrolyte, sealing, and performing formation charge/discharge cycles (i.e., “forming” a cell) (block 126).

The illustrated process does not include any upstream operations for preparing active materials, such as forming structures (e.g., particles, fibers) with desired sizes and compositions. These operations further complicate the electrode preparation phase 120 of cell fabrication. Moreover, certain materials and shapes (e.g., long fibers) can not be easily processed using traditional processing techniques.

In certain examples, different operations than the ones illustrated in FIG. 1 are used for electrode preparations. For examples, substrate-rooted nanowires may be directly deposited onto a substrate from precursor materials. Some of these processes are described in U.S. patent application Ser. No. 12/437,529, filed May 7, 2009 and U.S. patent application Ser. No. 61/181,637, filed May 27, 2009, which are incorporated herein by reference for the purposes of describing active materials and electrode structures as well as the corresponding fabrication processes.

Active materials formed as nanostructures, and more specifically as nanofibers, exhibit certain unique and unexpected electrochemical properties and may be highly desirable for certain electrode applications. For example, silicon nanowires can be formed in such way that they do not experience stress levels above the silicon fracture limit during lithium insertion in high capacity anodes with good cycling properties. Further, replacing particles with elongated structures (with one dimension being substantially larger than the two others) can improve other properties, including certain electrical and mechanical properties.

### Electrospinning Apparatus

It has been unexpectedly found that an electrospinning technology can be adapted to fabricate certain active materials and electrodes for use in electrochemical cells. The electrospinning process uses an electrical charge to draw a thin stream of liquid precursor, such as viscous or viscoelastic material, which later solidifies into a fiber, from the liquid. It shares certain characteristics of electro-spraying and conventional solution dry spinning. Electrospinning may involve both dissolved and molten precursors.

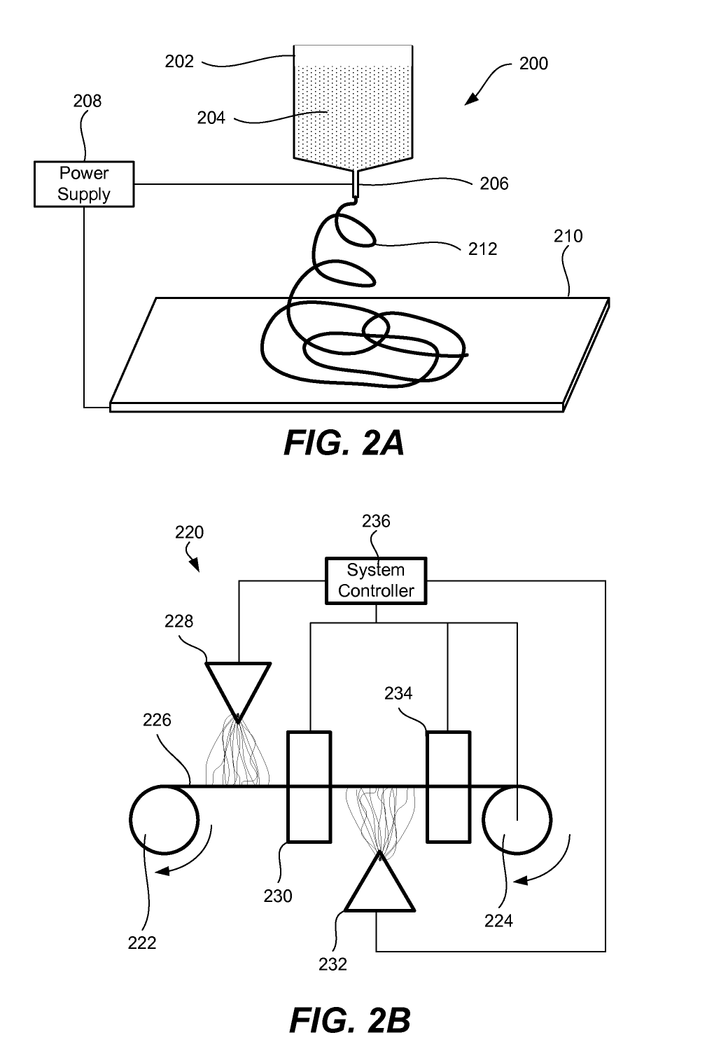

FIG. 2A shows an illustrative example of an electrospinning apparatus 200 in accordance with certain embodiments. The apparatus may include a vessel 202 for holding a liquid precursor 204. The vessel 202 may be a syringe, feeding tube, or any other suitable container. The vessel 202 is replenished with a liquid precursor. A mechanism (not shown) may be used to ensure composition, consistency, viscosity, and other parameters of the liquid precursor 204. The vessel 202 may include one or more nozzles 206 for delivering a thin stream of liquid from the vessel 202. Each nozzle 206 delivers an individual stream of the liquid precursor that solidifies into a fiber. In certain embodiments further described below, a stream and the resulting fiber may include a plurality of materials arranged in various combinations, such as a core-shell structure. A special combinational co-axial nozzle is used for this type of process.

A design of the nozzle affects dimensions, cross-section profile, and other parameters of the exiting stream and resulting fibers. In addition to the nozzle design, other process parameters that may be controlled in the electrospinning process include: polymer molecular weight, molecular weight distribution and structure, polymer solution properties (e.g., viscosity, conductivity, dielectric constant, surface tension), electric potential, flow rate, concentration, distance between needle and substrate, ambient temperature, and humidity, etc. Some of these parameters are further discussed below.

In some embodiments, fibers may form flattened/ribbon-like structures due to flattening during impact with a collector plate or forming a collapsible polymer skin. Examples of polymers and solvents with flattened morphology include: polyvinyl alcohol and water, poly ether imide and hexafluoro-2-propanol, nylon-6 and hexafluoro-2-propanol, polystyrene and dimethyl-formamide or tetrahydrofuran. Further certain polymers (e.g., polyvinylidene fluoride, poly 2-hydroxyethyl methacrylate, polystyrene, polyetherimide) can form branch like structures because of instability in a stream.

A number of nozzles, in addition to other factors, determines a rate of deposition. Multiple nozzles across the moving web may be used to provide an adequate deposition rate and ensure uniformity of nanofibers distribution across the web. In certain embodiments, a number of nozzles may be between about 1 and 1000, more specifically between 10 and 200, and even more specifically between 50 and 150. While a larger number of nozzle provide greater output (assuming the same diameter), which may be needed for high speed web deposition processes, in some embodiments, a large number of fibers may present difficulties in arranging individual fibers. For example, in battery fiber embodiments described below, each fiber is handled individually after deposition, which may restrict a number of nozzle used in parallel processes.

In certain embodiments, a nozzle 206 is a metallic needle. Generally, a nozzle is made out of the conductive material. An internal diameter of the nozzle typically depends on the desired fiber diameter and certain process parameters listed above (e.g., viscosity, surface tension, applied voltage, distance). Another design parameter of the nozzle design is the shape of the tip, which may be a flat tip. A combination of these parameters are selected such that a Taylor cone formed by a liquid stream at the end of the tip provides a smooth stream of liquid that ensures continuity of the resulting fiber.

The nozzle 206 is connected to a power supply 208 (e.g., 5-50 kV). The power supply 208 is also connected to a collector plate 210 made of conductive material. The collector plate 210 may be a rotating drum, moving web, or other shapes. Motion of the collector plate 210 with respect to the nozzle 206 provides even distribution and collection of the fibers. In certain embodiments, both the nozzle 206 and the collector plate 210 may be in motion.

In certain embodiments, one or more nozzles in the array of the nozzles may have its stream discontinued (i.e., “turned off”) while the remaining nozzles continue to deliver their streams. This may be accomplished by turning off the voltage applied to the specific nozzles that needs to be turned off. The cycling of streams in the array of the nozzles may be used to accomplish a desired distribution of the fibers on the surface.

When a sufficiently high voltage is applied between the collector plate 210 and the nozzle 206, it may draw a stream of the liquid precursor 204 out of the nozzle 206 (i.e., the electrostatic force exceeds the surface tension). Initially, a droplet is formed on the nozzle. The droplet is then stretched and eventually erupts at a critical point forming a stream. A shape of the liquid at the point of eruption is sometimes referred to as the Taylor cone.

The voltage should be sufficiently high to overcome the surface tension of the liquid precursor at the tip of the nozzle and to pull the liquid into a stream. At the same time, it is generally desirable that the electrostatic force does not overcome the surface tension within the moving stream, such that a continuous stream is delivered to the collector plate. The stream of the precursor accelerates towards the plate, which may cause stretching and thinning. Further, the stream may be elongated by a “whipping” process caused by electrostatic repulsion within a stream initially causing small bends that further increase towards the collector.

The following list includes some parameters that are generally considered in electrospinning process: average molecular weight of a polymer in a liquid precursor (including molecular weight distribution and structural characteristics of the polymer), solution properties (e.g., viscosity, conductivity, and surface tension), electric potential, flow rates, distance between the nozzle and the collector plate, ambient conditions (temperature, humidity, and air flow), motion of the collector.

FIG. 2B illustrates an example of apparatus 220 for electrospinning deposition of one or more layers of electrode materials on a moving web substrate. The apparatus 200 includes an unwind roll 222 supplying a substrate web 226 to the deposition area and rewind roll 224 collected the substrate with the deposited layers. The substrate web 226 moves with a predetermined speed controlled by a system controller 228 through the deposition area. In certain embodiments, the speed of the substrate web is between about 1 and 100 meters/min, or more specifically between about 2 and 30 meters/min.

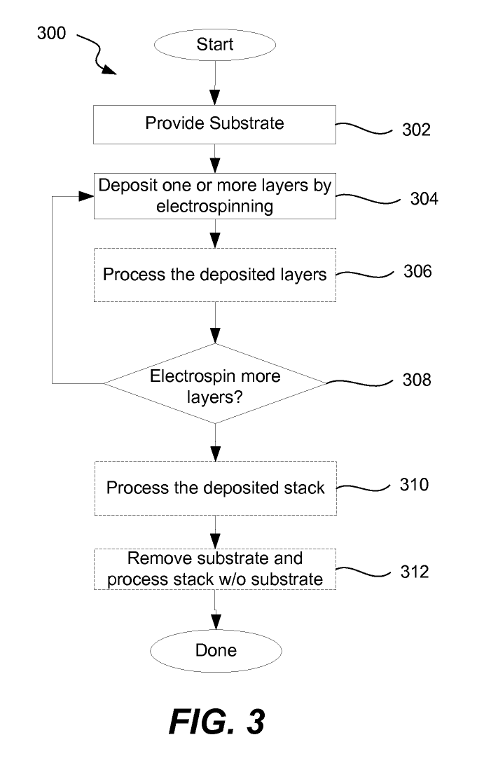

The apparatus 200 may include one or more electrospinning units (elements 228 and 232) and one or more post-deposition processing units (elements 230 and 234). While FIG. 2 illustrates an apparatus with two electrospinning units depositing fibers on the opposite sides of the substrate and two post-deposition processing units, it should be understood that any number and configurations of such units may be used. Additional details are presented in the context of FIG. 3 below.

An electrospinning unit (elements 228 and 234) is configured to deposit one or more fibers onto the substrate 226. In certain embodiments, the deposited fibers form an active layer with the electrode. An electrospinning unit is configured to ensure uniformity of the layer across and along the web of the substrate. For example, a unit may have a moving nozzle across the substrate width. Further, the apparatus may be equipped with a sensor measuring amount of fibers deposited on the substrate (e.g., laser backscatter, beta particles penetration, gamma backscatter) in various location on the substrate and adjust the deposition parameters accordingly.

A post-deposition processing unit (elements 230 and 234) may be used for converting deposited fibers to a new material and change form and/or function of the deposited. For example, such units may be used for sintering to convert deposited polymer-like fibers into ceramic fibers, evaporate remaining solvent, redistribute and/or compress the deposited layer, and perform other functions. Additional details of post-deposition operations are presented in the context of FIG. 3 below.

A substrate 226 may be a metallic foil. In this case, one contact of the power supply, which may be a part of the system controller 236 as illustrated in FIG. 2B, is electrically coupled to the substrate 226. For example, an electrical brush is provided below the deposition area to ensure sufficient voltage gradient between the deposition area and the corresponding nozzle. In some embodiments, a contact to the power supply may be established with one of the rolls. One contact point with the substrate may be sufficient to support multiple electrospinning units.

In other embodiments, the substrate 226 is an insulating material. For example, the power supply may be attached to a conductive element (e.g., a plate, roll) that is positioned behind the substrate 226.

Typically, electrospinning deposits fibers as nonwoven mats, in which the fibers are randomly oriented. In certain embodiments, a collector of the electrospinning apparatus includes a special feature, such as an insulating gap, that helps to uniaxially align deposited fibers.

A system controller 236 may be also used to control the process parameters in electrodeposition units. Some of the process parameters are described above in the context of FIG. 2A. Additional details of the electrospinning process and apparatus are described in U.S. Pat. No. 6,713,011, issued on Mar. 30, 2004 to Chu, B., et. al., Ramakrishna, S., “Electrospinning and Nanofibers”, published in 2005 by World Scientific Publishing Co., and Andrady, A., “Science and Technology of Polymer Nanofibers”, published in 2008 by John Wiley & Sons, which are incorporated herein by reference for the purposes of describing these details.

### Process

FIG. 3 illustrates an example of a general process for depositing one or more layers (e.g., multiple electrode layers such as anode-separator-cathode, a single composite layer, or a combination of the two) in accordance with certain embodiments. The process may start with providing a substrate into a deposition area (block 302). The deposition area is usually defined by a collector, which may be a substrate itself or a separate component of the apparatus positioned under the substrate (in the later case, the substrate is made of insulating materials). If the substrate acts as a collector (i.e., a voltage is applied between the substrate and the nozzles), then the deposition area may be defined by mechanical stops (e.g., walls preventing fibers from depositing outside of the area) or electrical shields (e.g., bias rings that reshape the electrical filed between the nozzle and the substrate).

The substrate may be an individual plate or a continuous web. In certain embodiments, the substrate is an intermediate carrier (e.g., a foil from which deposited fibers are later removed). In other embodiments, the substrate is a part of the electrode to which deposited fibers are permanently attached, such as a current collector of the electrode positioned in between the active layers, a previously deposited active layer, or any other element. A substrate may be a metallic foil (e.g., copper foil, stainless steel foil, aluminum foil, titanium foil), a polymer foil (e.g., Mylar film), a polymer paper (that may be converted to carbon after calcination), carbon fiber paper, carbon fiber mesh, and the like. The thickness of the substrate may be between about 1 μm and 1,000 μm or, in more specific embodiments, between about 5 μm and 100 μm.

The process continues with electrospinning fibers onto the surface of the substrate to form one or more electrode layers (block 304). Certain details of electrospinning are described above in the context of FIG. 2A. In one embodiment, a layer of fibers is deposited on the substrate and the process continues with another operation, which is performed only on the layer of fibers. In another embodiment, two layers of fibers are deposited on the opposite sides of the substrate before proceeding to the next operation. One layer may be an anode active material layer and the other may be a cathode active material layer, for example. In some cases, a deposited layer requires annealing or some other post-treatment. In one example, a layer deposited on one side may be annealed or otherwise treated before depositing a layer on the other side. In another example, both layers are deposited and then treated together. Certain details of the annealing are described in the context of operation 306. In some cases, the two separate layers are deposited on the same side of the substrate. This might be case when, for example, the first layer is an anode or cathode layer and the second layer is a separator layer.

Generally, one battery layer (e.g., a separator layer, an anode layer, or a cathode layer) is deposited before proceeding with another layer deposition. For example, an anode layer is deposited, followed by deposition of a separator layer, which then followed by deposition of a cathode layer. This approach helps to prevent electrical shorts between the anode and the cathode. Certain specific embodiments, which are referred to herein as “battery fibers” and further described above or below, may not generally follow this approach because one element of the fiber (i.e., a separator core) serves as a insulator.

In certain embodiments, a battery may include two more different types of fibers each containing a different component, and which form what is sometimes referred to as a composite electrode layer. These different fibers may be deposited in a single operation or a set of sequentially operations. For example, a plurality of jets above one deposition area may include jets with different materials. The composition of the layer may be controlled by turning certain jets off or on according to the procedures described above. For example, an anode layer may include silicon nanofibers and carbon nanofibers that are deposited in a single operation.

Orientation of fibers deposited on a substrate may be controlled with an electric field, e.g., changing applied voltage, applying voltage bias rings and other electrospinning apparatus elements that are designed to modify the field. Fiber orientation during deposition determines density, porosity, cross-linking, and other parameters of the deposited layer. In certain embodiments, these parameters are modified in one or more post-deposition operations.

After one or more layer is deposited in operation 304, the process may include an optional operation to further process these layers (block 306). For example, deposited layers may be converted to new materials by annealing, calcining, sintering, cooling, etc. In one example used to generate ceramic fibers, sintering is performed at between about 300° C. and 700° C. for between about 1 hour and 24 hours. In other embodiments, the post-deposition processing operation (block 306) may involve compressing a deposited layer by passing it, for example, through a roll press or placed between two plates for a predetermined period of time. In certain embodiments, the press may be heated to between about 30° C. and 300° C., more specifically between about 50° C. and 150° C.

In other embodiments, a post-deposition processing operation (block 306) includes depositing another material onto electrospun fibers. For example, carbon fiber electrospun in operation 304 may be coated with amorphous silicon to form “core-shell” structures. Additional details on core-shell structures are described in U.S. Patent application No. 61/181,637 referenced above. It should be noted that many core materials presented in that reference may be deposited using electrospinning. In certain embodiments, one or more shell materials may be formed together with the core using electrospinning. Post-deposition processing depends on the materials used in electrospinning that are further described below together with the corresponding post-deposition operations.

Operation 304 and, optionally, operation 306 may be repeated if additional layers need to be deposited (decision block 308). For example, a first cycle (including operations 304 and, optionally, 306) may be used to deposit a layer of separator. The cycle may be then repeated to deposit a layer of anode materials, another layer of separator, and a layer of cathode materials. These layers are also referred to as battery layers. The four battery layers deposited in this process form a separator-anode-separator-cathode stack, which may be then processed into a jelly roll or stack.

In one embodiment, a stackable battery (containing one or more anode-separator-cathode stacks) may be built by repeating the cycle described above. The layers of the battery may be deposited until the desired number is achieved. This allows creation of batteries having uniquely defined form factors, and also allows elimination of certain mechanical operations typically used in arranging and handling the stack.

In certain embodiments, a single battery layer may be deposited in a multi-step or cyclic process instead of a single deposition operation. For example, a sub-layer may require an intermediate treatment (e.g., annealing, coating fibers with another materials, compressing) before the deposition can be continued.

Once, all electrospun layers are deposited on the substrate, the entire stack, which in certain embodiments may include only one layer, may be subjected to post deposition processing (block 310). This operation is optional and, in some embodiments, the stack may be ready for use in battery electrodes immediately after operation 304 and, optionally, operation 306. Some forms of this processing have been already described in reference to operation 306. The processing may be used to enhance mechanical and electrical contacts between the electrospun layers.

In certain embodiments, a stack includes multiple battery layers, for example, anode-separator, cathode-separator, anode-separator-cathode, anode-separator-cathode-separator. The entire stack is subjected to one or more post deposition treatments, such as annealing. Annealing may be performed at between about 300° C. and 700° C. to convert materials of the stack to ones desirable for battery applications. For example, a separator layer may be converted into an inorganic material, such as ceramic.

In some embodiments, the substrate may be removed from the stack (block 312). This operation is optional and, in some embodiments, the stack may be used as an electrode material together with the substrate. For example, a metallic foil may be as a substrate and active materials are deposited on the surface of the foil. The foil may remain as a current collector in the resulting electrode.

### Battery Layer Examples

Materials are provided to an electrospinning apparatus in a liquid form, either as solution containing, e.g., a polymer base and a solvent or a melt. Polymer examples include: Nylon 4,6, Nylon 6, Nylon 6,6, Nylon 12, Polyacrylic acid, Polyacrylonitrile, Polyamide-6, Poly(benzimidazol), Polycarbonate, Poly(etherimide), Poly(ethyelene oxide), Poly(ethylene terephthalate), Polystyrene, Poly(styrene-butadiene-styrene) triblock copolymer, Polysulfone, Bisphenol-A, Poly(trimethylene terephthalate), Poly(urethane), Poly(urethane urea), Poly(vinyl alcohol), Poly(vinyl carbazole), Poly(vinyl chloride), Poly(vinyl pyrrolidone), Poly(vinylidene fluoride), Poly(vinylidne fluoride-co-hexafluoropropylne), Degradable Polyesterurethane, Poly(ε-caprolactone), Polydioxanone, Polyglycolide, Poly(L-lactic acid), Poly(D,L-lactide-co-glycolide), Poly(L-lactide-co-glycolide), Poly(lactic-co-glycolic acid), Poly(L-lactic-co-glycolic acid), Fibrinogen Fraction, Gelatin, Wheat Gluten. Solvent examples include: Formic acid, Hexafluoro-2-propanol, Ethanol, Dimethylformamide, Dimethyl acetamide, Dichloromethane, Chloroform, Tetahydrofuran, Trichloroethane, Water, Trifluoroacetic acid, t-Butylacetate, Chlorobenzene, Ethylacetate, Methylethylketone, Tetrahydrofuran, Methylene Chloride, Isopropyl alcohol, Hexafluoro-2-propanol, Hexafluoroisopropanol, Aqueous triethanolamine, Methylene Chloride, Trifluorethanol.

In one embodiment, a liquid precursor used in electrospinning is a slurry that includes a polymer base and small rod-like or elongated particles. These particles must be sufficiently small to pass through the nozzle of the electrospinning apparatus. For examples, round-like particles may be less than about 1 μm or, more specifically, less than about 100 nm. The diameter of elongated particles (e.g., nanowires) may be between about 5-1000 nm or, more specifically, between about 10-300 nm. The length of elongated particles may be less than about 10 μm, more specifically less than about 5 μm, or even more specifically less than about 1 μm. In certain embodiments, the elongated particles are nanostructure and/or nanowires such as those described in U.S. patent application Ser. No. 12/437,529, filed May 7, 2009 and U.S. Patent application No. 61/181,637, filed May 27, 2009, which are incorporated herein by reference for the purposes of this description. These materials may be combined with a polymer base material, examples of which are listed above. In a specific example, nanowires may be coated with carbon before combining with a polymer base.

In another example, a core and one or more shells may be electrospun in a single operation. For example, two or more different materials may be co-spun from a special nozzle and form a core-shell structure immediately upon leaving the nozzle. A specific example of these embodiments, which is referred to as a “battery fiber”, is described below. Other examples may include an active core (e.g., silicon) and a carbon shell, a carbon core and an active shell, and a carbon core-active shell-carbon outer shell. The core of some of these structures may have a diameter of less than about 200 nm. The thickness of the outer carbon shell may be less than about 50 nm. Certain examples of these structures are described in U.S. Patent application No. 61/181,637, filed May 27, 2009, which is incorporated herein by reference in its entirety for the purpose of describing these multi-layered structures. Such fibers may be generated in a single electrospun operation followed by one or more post-deposition treatments (e.g., calcining, sintering, annealing, cooling, or carbonizing) described above.

In certain embodiments, a homogeneous fiber may be electrospun and then treated in such way that only a part of the material in the fiber is transformed forming a core and a shell having different composition, morphological structure, or other properties.

Examples of materials used for electrospinning positive active layer includes: LiCoO—MgO, lithium titanate (LTO), and others. For example, LTO fibers can be produced by using titanium tetraisopropoxide and lithium hydroxide as precursors in the polymer mixture. The resulting polymer fiber may be calcined or sintered to create carbon fiber backbones. Within the fiber, the titanium precursor reacts with lithium hydroxide and produce LTO nanoparticles. This approach can be used to produce other cathode oxides such as lithium cobalt oxide, lithium manganese oxide and inorganic separator, such as aluminum oxide and silicon dioxide. Further, electrospinning may be used to produce LiFePO₄ fibers including various doped LiFePO₄ fibers such as those promoted by A123 Corporation. For example, pre-synthesized active materials using nanoparticles or nanowires can be mixed with the polymer solution to form a nanomaterial/polymer suspension (also referred to as a slurry or paste). Electrospinning of the mixed solution can generate polymer fibers with nanoparticles or nanowires embedded. The carbonizing step may be needed to convert the organic polymer to carbon.

Examples of materials used for electrospinning negative active layer include: silicon, carbon, germanium, tin, aluminum, tin oxide, alkoxysilanes as a Si precursor, and others. In certain embodiments, these materials are organized into core-shell structures such as silicon-core/carbon-shell, carbon-core/silicon-shell, or carbon-core/silicon-inner-shell/carbon-outer-shell. In the same or other embodiments, the entire layer or a part of the layer (e.g., a core, shell) may be a mixture of materials, such as a carbon and silicon. For example, a carbon may be mixed with titanium oxide.

Other examples of positive and negative active materials can be found in U.S. patent application Ser. No. 12/437,529, filed May 7, 2009 and U.S. Patent application No. 61/181,637, filed May 27, 2009, which are incorporated herein by reference in their entireties for the purpose of describing these positive and negative active materials.

Examples of materials used for electrospinning separator layer includes: PVDF, polypropylene, inorganic materials (SiO₂, Al₂O₃, TiO₂), organically modified ceramics (including oxides of Al, Si, Ti, and Zr modified with silicones and organic polymers), and others. Inorganic separator materials allow combining these materials with other layers (e.g., cathode and anode) and treating an entire stack together because these inorganic materials continue to obtain (to some degree) and continue to retain their ionic conductivity properties when being exposed to high temperatures involved in calcination, sintering, annealing, and carbonization.

Some examples of materials that can be deposited using electrospinning and subsequent treatments are provided in the table below.

TABLE 1

| Battery | |
|---|---|
| component | Principal material |
| Anode | Carbon, Silicon, Lithium Titanate, etc. |
| Cathode | Lithium Cobalt Oxide, Lithium Manganese Oxide, Lithium |
| | Iron Phosphate, Lithium Nickel-Cobalt-Aluminum Oxide, |
| | etc |
| Inorganic | Inorganic: Silicon Dioxide, Aluminum Oxide, Titanium |
| Separator | Oxide, etc |
| | Polymer-inorganic hybrid: polymer blended with the above |
| | inorganic materials. |

In certain embodiments, electrospun fibers have nanoscale diameters (e.g., less than about 1000 nanometers, or less than about 500 nanometers, or even less than about 100 nanometers). In the same or other embodiments, electrospun fibers have relative large lengths (e.g., at least about 10 millimeter, or at least about 1 centimeter, or even at least about 1 meter).

### Battery Fiber

A battery fiber is a fiber that contains multiple shells and, possibly, a core, such that at least two elements of this fiber (a core and a shell, or two shells) are electrically separated from each other by a core. A core that provides electrical separation functions as a separator and should provides ion migration between the two separated elements. One of the separated elements includes anode active materials, while another include cathode active materials. In certain embodiments, the inner element (out of the two separated elements) includes anode active materials, while in other examples the outer element includes anode materials.

The separated elements have sufficient conductivity to pass electrons along fiber lengths to the current collector. One current collector is attached to the anode element of the fiber, while another current collector is attached to the cathode element. A connection may be made an outer shell or to an extending core or inner shell containing of these elements. A fiber may be formed to a predetermined length (e.g., 100 μm-100 mm, or more specifically between 1-50 mm) by “turning” off or on corresponding parts of a nozzle, which is further described below. Further, an extended core or inner shell that is needed to establish one an electrical connection may be formed by synchronizing different parts of the nozzle.

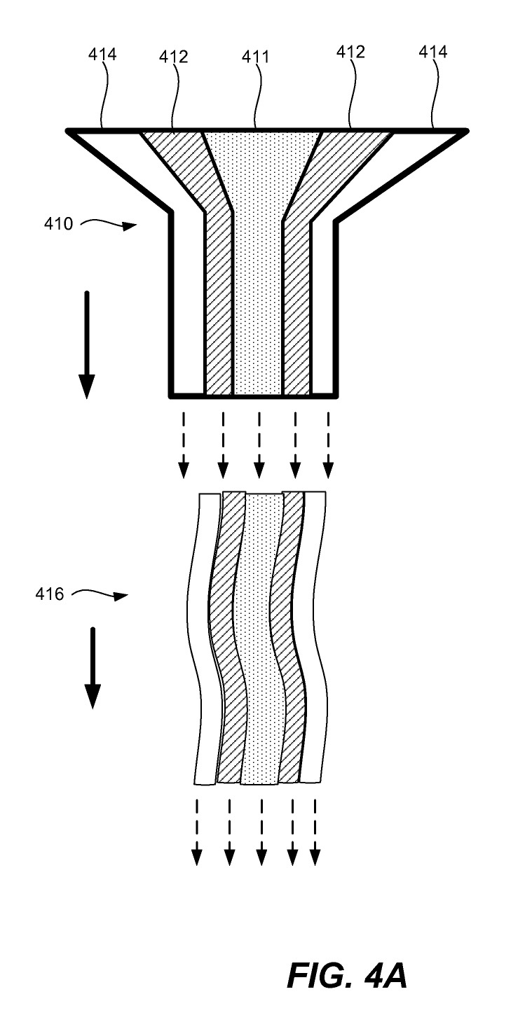

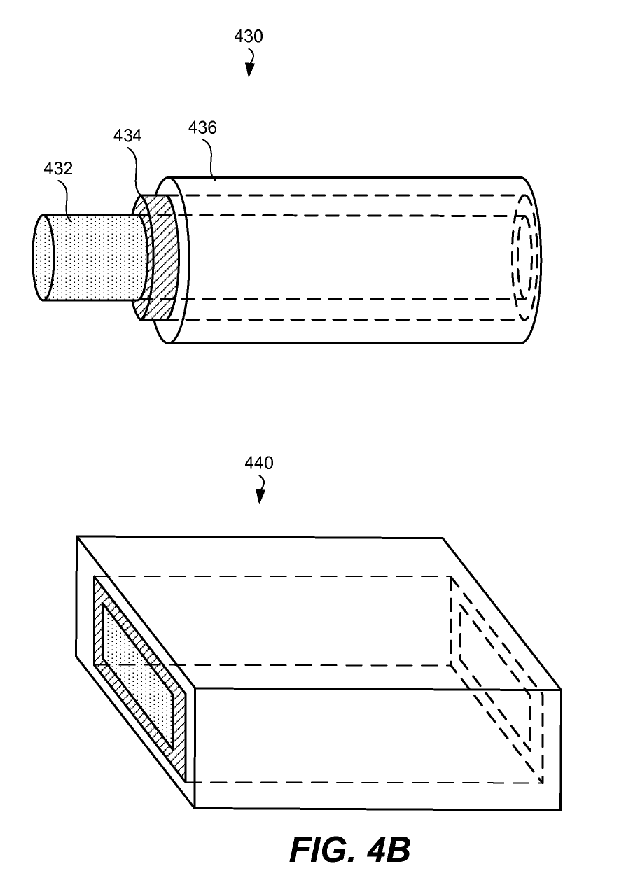

FIG. 4A is an illustrative representation of a battery fiber 416 ejected from the electrospinning nozzle 410. The nozzle 410 is configured in such way that it delivers a core and at least two shells around this core in the exiting stream. For example, a nozzle 410 may have a set of three concentric tubes. The inner tube may deliver material 411 to form a core of the battery fiber. In certain embodiments, the core may result in a hollow cylinder after drying out the solvent and performing post-deposition treatments. In other embodiments, the inner tube may not deliver a material and a resulting battery fiber is without a core. The next innermost tube of the nozzle 410 carries material 412 for the innermost shell of the battery fiber 416. The next tube carries material 414 for the next shell. It should be understood that the nozzle may be designed to include additional tubes. Certain tubes, typically outer tubes, may protrude further than the inner tubes (not shown) in order to form the outer boundaries of the fiber, once the streams of multiple materials (e.g., 411, 412, 414) are combined. Further, the longer tubes may slightly taper towards the opening end in order to bring the streams of multiple materials together. In the same or other embodiments, combining the layers into a single body is achieved by selecting polymers with desirable properties (surface tensions, viscosities), controlling the drying process in such way that materials “collapse” together, establishing voltage gradients between various tubes of the nozzle 410.

FIG. 4B illustrates two examples of battery fibers in accordance with certain embodiments. A battery fiber 430 is shown to have a core 432, an inner shell 434, and an outer shell 436, which form a set of concentric round cylinder. It should be understood that other shapes are possible that are not concentric, round, or form a complete closed shapes. For example, a core-shell structure may have one or more of the cores that not necessarily cover the inner core or shell. Additional shapes and forms of the core-shell structure are described in U.S. Patent application No. 61/181,637, filed May 27, 2009.

As described above, a battery fiber includes at least two electrically separated elements. For example, the battery fiber 430 may have a core 432 with anode materials, an inner shell 434 with separator materials, and an outer shell 436 with cathode materials. Many of these materials are described above. Further, additional shells may be present, such that other elements of the core-shell structure include anode, separator, and cathode materials. In certain embodiments, a battery fiber may include multiple anode-separator-cathode layer combinations, such as anode core-separator shell 1—cathode shell 2—separator shell 3—anode shell 4.

In certain embodiments, one or more inner layers of a fiber extend in order to form an electrical and mechanical connection and provide insulation between the layers. For example, FIG. 4B illustrates a battery fiber with a shell 434 extending beyond the shell 436 on one end. The core 432 extends even further. It should be note that similar examples can be provided on both ends of the fiber. In the example, where the core 432 includes anode material, the inner shell 434—separator, and outer shell—cathode, the extended portion of the core may be used to form an electrical connection to the core 432 (and anode). Further, extending the separator (inner shell 434) beyond the cathode (outer shell 436) help to ensure electrical insulation between the cathode and anode of the nanowire.

In certain example, a battery fiber may have a flattened portion, for example as illustrated by a rectangular core-shell fiber 440 in FIG. 4B. The flattened portion of such battery fibers may be formed during forming liquid streams (e.g., defined by a nozzle), flattened when collected on the collector (e.g., due to impact or pressed after collection), or during subsequent post-deposition treatment operations. In certain embodiments (not shown), the flattened battery nanofibers can be wound in to a jelly roll or stacked.

### Patched Deposition

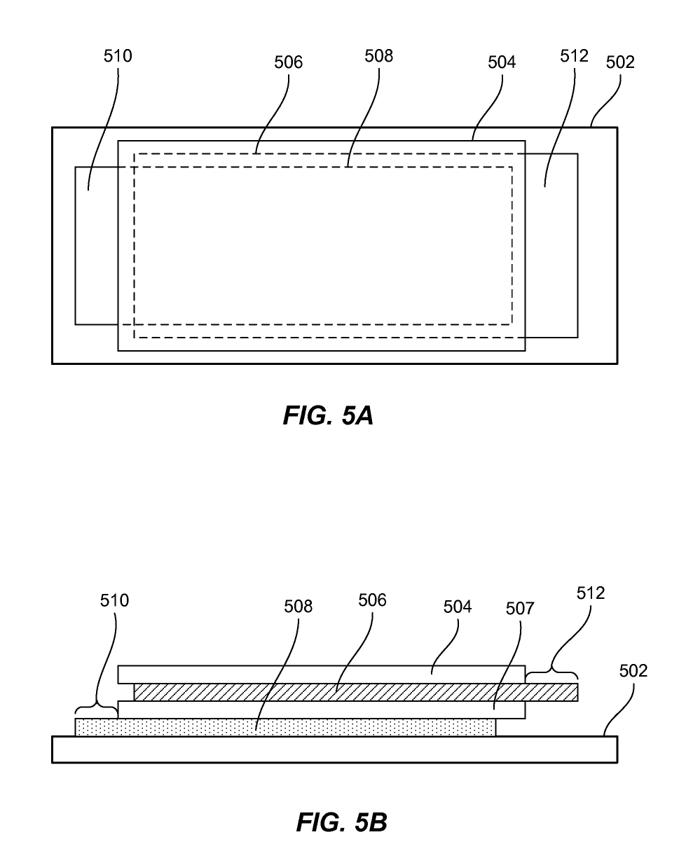

FIGS. 5A and 5B illustrate top and side views of a patch including a substrate 502 and four battery layers (504, 506, 507, and 508) in accordance with certain embodiments. Such path may be formed during depositing the layers on the substrate using electrospinning process described above. Each layer may be an electrode layer. For example, the layer 508 may include cathode materials, the layers 504 and 507 may include separator materials, while the layer 506 may include cathode materials. The patches may be formed on the substrate in such way that upon slitting and removal of the substrate 502, the strips may be rolled directly into jelly rolls without addition of any other electrode or separator components. In other embodiment, other materials, such a layer of a separator, may be added to the winding process.

In a multi-layered electrode structure, such as the one shown in FIGS. 5A and 5B, a layer containing cathode materials and a layer containing anode materials have to form an electrical connection with terminals of an electrochemical cell. To achieve this connection a portion of these layers has to extend beyond the stack. As shown in the figure, the layer 508 has an extended portion 510, while the layer 506 has an extended portion 512. These extended portions can be formed when other layers of the stack are not deposited in the corresponding areas. For example, in a continuous web deposition process, electrospinning should be controlled in such way that fibers of the other layer don't extend into these areas. As described above, electrospinning process may be stopped by tuning off voltage for the corresponding nozzles or other methods. The operations of nozzles depositing different layers is synchronized in order to achieve a desired structure (and free extended ends of certain layers). Further, various sensors may be used to detect edges of the previously deposited layers and to actuate nozzles for depositing subsequent layers based of the position of the edge.

### Battery Assembly

Electrode materials and structured described above can be used to fabricate lithium ion and other battery types. Beside cathode, anode, and separator materials, these batteries may use an electrolyte. A typical liquid electrolyte comprises one or more solvents and one or more salts, at least one of which includes lithium. During the first charge cycle (sometimes referred to as a formation cycle), the organic solvent in the electrolyte can partially decompose on the anode surface to form a solid electrolyte interphase layer (SEI layer). The interphase is generally electrically insulating but ionically conductive, allowing lithium ions to pass through. The interphase also prevents decomposition of the electrolyte in the later charging sub-cycles.

Some examples of non-aqueous solvents suitable for some lithium ion cells include the following:
cyclic carbonates, such as ethylene carbonate (EC), propylene carbonate (PC), butylene carbonate (BC) and vinylethylene carbonate (VEC)
lactones, such as gamma-butyrolactone (GBL), gamma-valerolactone (GVL) and alpha-angelica lactone (AGL)
linear carbonates such as dimethyl carbonate (DMC), methyl ethyl carbonate (MEC), diethyl carbonate (DEC), methyl propyl carbonate (MPC), dipropyl carbonate (DPC), methyl butyl carbonate (NBC) and dibutyl carbonate (DBC)
ethers such as tetrahydrofuran (THF), 2-methyltetrahydrofuran, 1,4-dioxane, 1,2-dimethoxyethane (DME), 1,2-diethoxyethane and 1,2-dibutoxyethane
nitrites such as acetonitrile and adiponitrile; linear esters such as methyl propionate, methyl pivalate, butyl pivalate and octyl pivalate; amides such as dimethyl formamide
organic phosphates such as trimethyl phosphate and trioctyl phosphate; and
organic compounds containing an S═O group such as dimethyl sulfone and divinyl sulfone.

Non-aqueous liquid solvents can be employed in combination. Examples of the combinations include combinations of cyclic carbonate-linear carbonate, cyclic carbonate-lactone, cyclic carbonate-lactone-linear carbonate, cyclic carbonate-linear carbonate-lactone, cyclic carbonate-linear carbonate-ether, and cyclic carbonate-linear carbonate-linear ester. In one embodiment, a cyclic carbonate may be combined with a linear ester. Moreover, a cyclic carbonate may be combined with a lactone and a linear ester. In a specific embodiment, the ratio of a cyclic carbonate to a linear ester is between about 1:9 to 10:0, preferably 2:8 to 7:3, by volume.

A salt for liquid electrolytes may include one or more of the following: LiPF₆, LiBF₄, LiClO₄LiAsF₆, LiN(CF₃SO₂)₂, LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), Lithium salts having cyclic alkyl groups such as (CF₂)₂(SO₂)₂ₓLi and (CF₂)₃(SO₂)₂ₓLi, Common combinations examples include LiPF₆ and LiBF₄, LiPF₆ and LiN(CF₃SO₂)₂, LiBF₄ and LiN(CF₃SO₂)_{2.}

In one embodiment the total concentration of salt in a liquid nonaqueous solvent (or combination of solvents) is at least about 0.3 M; in a more specific embodiment, the salt concentration is at least about 0.7M. The upper concentration limit may be driven by a solubility limit or may be no greater than about 2.5 M; in a more specific embodiment, no more than about 1.5 M.

A solid electrolyte is typically used without the separator because it serves as the separator itself. It is electrically insulating, ionically conductive, and electrochemically stable. In the solid electrolyte configuration, a lithium containing salt, which could be the same as for the liquid electrolyte cells described above, is employed but rather than being dissolved in an organic solvent, it is held in a solid polymer composite. Examples of solid polymer electrolytes include the following: ionically conductive polymers prepared from monomers containing atoms having lone pairs of electrons available for the lithium ions of electrolyte salts to attach to and move between during conduction, polyvinylidene fluoride (PVDF) or chloride or copolymer of their derivatives, poly(chlorotrifluoroethylene), poly(ethylene-chlorotrifluoro-ethylene), or poly(fluorinated ethylene-propylene), polyethylene oxide (PEO) and oxymethylene linked PEO, PEO-PPO-PEO crosslinked with trifunctional urethane, poly(bis(methoxy-ethoxy-ethoxide))-phosphazene (MEEP), triol-type PEO crosslinked with difunctional urethane, poly((oligo)oxyethylene)methacrylate-co-alkali metal methacrylate, polyacrylonitrile (PAN), Polymethylmethacrylate (PNMA), Polymethylacrylonitrile (PMAN), Polysiloxanes and their copolymers and derivatives, Acrylate-based polymer.

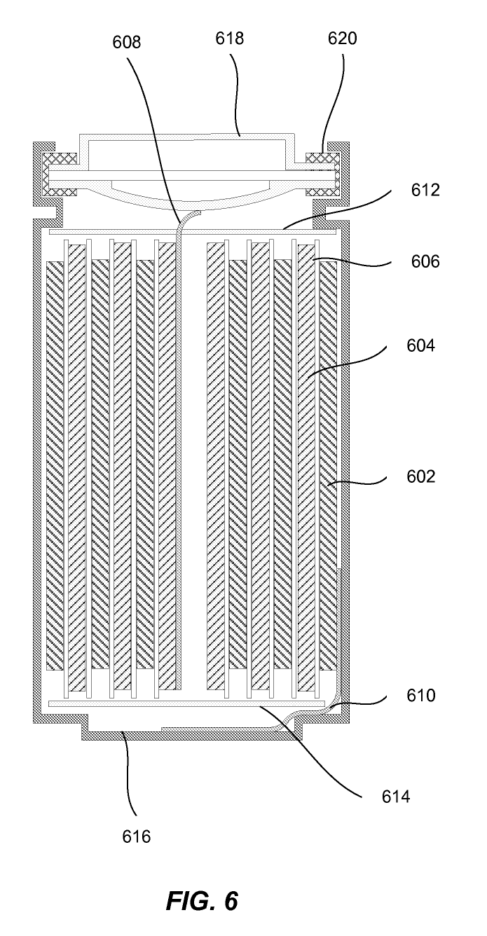

FIG. 6 illustrates a cross-section view of the wound cylindrical cell in accordance with one embodiment. A jelly roll comprises a spirally wound positive electrode 602, a negative electrode 604, and two sheets of the separator 606. The jelly roll is inserted into a cell case 616, and a cap 618 and gasket 620 are used to seal the cell. In some cases, cap 612 or case 616 includes a safety device. For example, a safety vent or burst valve may be employed to break open if excessive pressure builds up in the battery. Also, a positive thermal coefficient (PTC) device may be incorporated into the conductive pathway of cap 618 to reduce the damage that might result if the cell suffered a short circuit. The external surface of the cap 618 may used as the positive terminal, while the external surface of the cell case 616 may serve as the negative terminal. In an alternative embodiment, the polarity of the battery is reversed and the external surface of the cap 618 is used as the negative terminal, while the external surface of the cell case 616 serves as the positive terminal. Tabs 608 and 610 may be used to establish a connection between the positive and negative electrodes and the corresponding terminals. Appropriate insulating gaskets 614 and 612 may be inserted to prevent the possibility of internal shorting. For example, a Kapton™ film may used for internal insulation. During fabrication, the cap 618 may be crimped to the case 616 in order to seal the cell. However prior to this operation, electrolyte (not shown) is added to fill the porous spaces of the jelly roll.

A rigid case is typically required for lithium ion cells, while lithium polymer cells may be packed into a flexible, foil-type (polymer laminate) case. A variety of materials can be chosen for the case. For lithium-ion batteries, Ti-6-4, other Ti alloys, Al, Al alloys, and 300 series stainless steels may be suitable for the positive conductive case portions and end caps, and commercially pure Ti, Ti alloys, Cu, Al, Al alloys, Ni, Pb, and stainless steels may be suitable for the negative conductive case portions and end caps.

### Conclusion

Although the foregoing invention has been described in some detail for purposes of clarity of understanding, it will be apparent that certain changes and modifications may be practiced within the scope of the appended claims. It should be noted that there are many alternative ways of implementing the processes, systems and apparatus of the present invention. Accordingly, the present embodiments are to be considered as illustrative and not restrictive, and the invention is not to be limited to the details given herein.

What is claimed is:

1. A method for fabricating an electrode assembly comprising an electrochemically active material for use in a battery, the method comprising:
providing a thin film substrate having a first surface and a second surface;
depositing an initial layer comprising first electrospun fibers on the first surface using an electrospinning deposition technique, said electrospun fibers comprising the electrochemically active material; and
depositing a second layer comprising second electrospun fibers using the electrospinning deposition technique.

2. The method of claim 1, further comprising performing one or more operations on the first or second electrospun fibers, wherein the one or more operations selected from the group consisting of annealing, calcining, carbonizing, sintering, compressing, and cooling.

3. The method of claim 1, wherein the second layer is deposited on the second surface of the substrate.

4. The method of claim 3, wherein the initial layer and the second layer have substantially the same thicknesses and substantially the same compositions.

5. The method of claim 3, wherein the initial layer comprises a negative active material, wherein the second layer comprises a positive active material, and wherein the thin film substrate comprises a permeable membrane selected from the group consisting of a battery separator, a battery electrolyte, and a combination of a battery separator and electrolyte.

6. The method of claim 3, wherein the initial layer and/or the second layer comprise discrete patches positioned on the substrate with the first surface and/or the second surface of the substrate exposed in between these patches.

7. The method of claim 6, wherein the discrete patches are formed using two mechanical stops and/or an electrical shield.

8. The method of claim 1, wherein the second layer is deposited over the initial layer.

9. The method of claim 8, further comprising:
depositing a third layer comprising third electrospun fibers over the second layer, said third electrospun fibers comprising a different active material;
depositing a fourth layer comprising fourth electrospun fibers over the third layer, said fourth layer and said second layer have substantially the same thickness and substantially the same composition and comprising a material selected from the group consisting of a battery separator, a battery electrolyte, and a combination of a battery separator and electrolyte.; and
separating the initial layer from the substrate to form a stack comprising the initial layer, the second layer, the third layer, and the fourth layer.

10. The method of claim 9, further comprising winding the stack into a jellyroll and positioning the jellyroll into a battery case.

11. The method of claim 1, wherein the electrode assembly comprises an electrolyte material.

12. The method of claim 1, wherein the electrospun fibers of the initial layer comprise a first group of fibers comprising the electrochemically active material and a second group of fibers comprising a different electrochemically active material.

13. The method of claim 1, wherein depositing the initial layer comprises feeding a liquid precursor through an electrospinning nozzle, said liquid precursor comprising a polymer base and active material particles.

14. The method of claim 1, wherein the electrochemically active material is selected from the group consisting of silicon, germanium, and tin.

15. The method of claim 1, wherein the electrochemically active material comprises silicon nanowires.

16. The method of claim 1, wherein the substrate is a continuous foil selected from the group consisting of a copper foil, a stainless steel foil, an aluminum foil, a titanium foil, a Mylar film, a polymer paper, a carbon a fiber paper, and a carbon fiber mesh.

17. A method for fabricating an electrode layer comprising an electrochemically active material for use in a battery, the method comprising:
depositing an initial layer comprising electrospun fibers comprising the electrochemically active material and having core-shell structures comprising solid cores and solid shells, wherein the solid cores have different compositions than the solid shells; and
processing the initial layer to change shapes and/or compositions of the electrospun fibers to form the electrode layer, wherein processing the initial layer forms hollow cylinders from the solid cores.

18. The method of claim 17, wherein processing the initial layer comprises drying out a solvent from the electrospun fibers and/or performing one or more post-deposition treatments selected from the group consisting of annealing, calcining, carbonizing, sintering, compressing, and cooling.

19. A method for fabricating an electrode layer comprising an electrochemically active material for use in a battery, the method comprising:
depositing an initial layer comprising electrospun fibers comprising a polymer material;
forming a amorphous silicon coating silicon around the electrospun fibers; and
processing the initial layer comprising the electrospun fibers with the amorphous silicon coating to form the electrode layer.

20. The method of claim 19, wherein the electrospun fibers further comprise the electrochemically active material.

21. An electrode fiber for use in a battery electrode, the electrode fiber comprising:
a core comprising a first electrochemically active material;
a shell formed around the core and comprising one or more selected from the group consisting of a separator material and/or an electrolyte material; and
a second shell formed around the shell and comprising a second electrochemically active material that is electrochemically opposite to the first active material,
wherein the shell provides an electronic insulation between the core and the second shell and is configured to transport electrochemically active ions between the core and the second shell.
